(19) United States
(12) Patent Application Publication
(10) Pub. No.: US 2025/0094379 A1
(43) Pub. Date: Mar. 20, 2025

(54) DATA-FLOW-DRIVEN RECONFIGURABLE PROCESSOR CHIP AND RECONFIGURABLE PROCESSOR CLUSTER

(71) Applicant: Beijing Tsingmicro Intelligent Technology Co., Ltd., Beijing (CN)

(72) Inventor: Peng Ouyang, Beijing (CN)

(21) Appl. No.: 18/971,323

(22) Filed: Dec. 6, 2024

Related U.S. Application Data
(63) Continuation of application No. PCT/CN2023/142292, filed on Dec. 27, 2023.

(30) Foreign Application Priority Data
Jan. 31, 2023 (CN) 202310047127.8

(51) Int. Cl. G06F 15/78

(52) U.S. Cl. CPC G06F 15/7882

(57) ABSTRACT

A reconfigurable processor chip includes: a plurality of reconfigurable processing elements based on distributed storage, components of the reconfigurable processing elements being logically interconnected. The components include: a reconfigurable computing component configured to calculate data; a data flow controller using a data flow driving mode, the data flow driving mode is configured to control start and end of a computing task and a data transmission task based on data flow information about the computing task and message transferring of upstream and downstream reconfigurable processing elements; a distributed memory configured to implement data storage of a corresponding reconfigurable processing element; and a programmable data routing element configured to implement communication between the plurality of reconfigurable processing elements to control a direction of a data packet, and implement flexible transmission of the data packet.

### CROSS-REFERENCE TO RELATED APPLICATION

The present application is a Continuation Application of International Application PCT/CN2023/142292, filed Dec. 27, 2023, which claims the benefit of and priority to Chinese Patent Application No. 202310047127.8, filed Jan. 31, 2023, the contents of which are incorporated herein by reference in their entireties for all purposes.

### FIELD

The present disclosure relates to the field of reconfigurable computing technology, and in particular to a data-flow-driven reconfigurable processor chip and a reconfigurable processor cluster.

### BACKGROUND

At present, with expansion of application range of artificial intelligence and increase in task difficulty, an artificial intelligence algorithm represented by a deep neural network gradually evolves to the trend of a super large-scale model. The super-large scale model such as GPT-3 has parameters on an order of 100 billion. A large-scale model like GPT3 is trained once, even with thousands of graphics processing unit (GPU) servers for about a month. Therefore, improvement on performance of an intelligent computing processing system is crucial to training of the large-scale model.

Parallel processing of the large-scale model on a GPU cluster usually requires a variety of parallel strategies, including data parallel, model parallel, pipeline parallel strategies and the like to fully exert calculating parallelism. On the one hand, an algorithm mainly uses a way of the data parallelism on a GPU card, and it is impossible to mine parallelism of other dimensions of the algorithm, and thus a problem of low utilization of actual computing power is easy to occur. On the other hand, since distributed parallelism of the algorithm increases a large amount of communication demands, a problem of communication becomes one of main factors that affect performance of the system. At present, the GPU is based on an architecture of shared storage, and a flow processor inside a chip performs communication mainly by means of the shared storage, which is prone to generate a problem of access bottleneck. Traditional AI chip architectures, such as Google's TPU, are also mainly designed based on the architecture of shared storage. A problem of communication bottleneck is exacerbated by increased demand for distributed parallel communication. In order to solve the above problems, a development trend of design of a distributed AI hardware acceleration system is carried out by using a data flow driving mode. A data flow architecture is closer to characteristic of an AI algorithm, and computing and communication may be separated as much as possible to alleviate the problem of communication bottleneck under distributed computing of a large model.

In a computing scenario of a large-scale cluster, data trans-chip transmission between GPU computing cards results in low efficiency and high delay of data handling, which further becomes a major factor affecting improvement on system performance. Moreover, GPU cross-server communication further requires a high-speed network switch, so that cost of communication is large, cost of the high-speed network switch is high, and cost for establishing a large-scale GPU cluster is difficult to reduce.

### SUMMARY

The present disclosure provides a data-flow-driven reconfigurable processor chip and a reconfigurable processor cluster.

According to a first aspect of the present disclosure, there is provided a reconfigurable processor chip, including: multiple reconfigurable processing elements based on distributed storage, components of the reconfigurable processing elements being logically interconnected, where the components include:
a reconfigurable computing component configured to calculate data;
a data flow controller using a data flow driving mode, the data flow driving mode being configured to control start and end of a computing task and a data transmission task based on data flow information about the computing task and message transferring of upstream and downstream reconfigurable processing elements;
a distributed memory configured to implement data storage of a corresponding reconfigurable processing element; and
a programmable data routing element configured to implement communication between the plurality of reconfigurable processing elements to control a direction of a data packet, and implement flexible transmission of the data packet.

In one embodiment, the programmable data routing element is configured to change a routing direction and a routing destination of the data packet in real time by software configuration using a software programmable routing policy.

In one embodiment, the reconfigurable processing element is configured to exchange data over a network-on-chip, an inter-chip interface and a network cable within a storage capacity range of a storage space.

In one embodiment, the multiple reconfigurable processing elements are divided into multiple computing areas based on algorithmic mapping requirements, where a communication connection relationship of the programmable data routing element is changed in real time by changing configuration of an execution graph in the reconfigurable processing elements in the data flow driving mode of the data flow controller, and a division of the computing areas is changed based on the communication connection relationship.

In one embodiment, the multiple computing areas perform pipeline computing or perform different assigned computing tasks.

According to another aspect of the present disclosure, there is provided a reconfigurable processor cluster, including: multiple reconfigurable processor chips, where the reconfigurable processor chip is composed of the multiple reconfigurable processing elements based on the distributed storage, and the components of the reconfigurable processing elements are logically interconnected and include:
the reconfigurable computing component configured to calculate the data;
the data flow controller using the data flow driving mode, the data flow driving mode being configured to control the start and end of the computing task and the data transmission task based on the data flow information about the computing task and the message transferring of upstream and downstream reconfigurable processing elements (RPE);
the distributed memory configured to implement the data storage of the corresponding reconfigurable processing element; and
the programmable data routing element configured to implement the communication between the multiple reconfigurable processing elements to control the direction of the data packet, and implement the flexible transmission of the data packet.

In one embodiment, the reconfigurable processor cluster further includes: a routing control module being configured to implement data communication among the multiple reconfigurable processor chips,
where the reconfigurable processing element among the multiple reconfigurable processor chips is configured to perform the data communication via a network by the programmable data routing element and the routing control module, and the programmable data routing element and the routing control module on the reconfigurable processor chip are connected by the network on the reconfigurable processor chip; and
the routing control module is configured to receive or send a network data packet among the reconfigurable processor chips.

In one embodiment, the routing control module has a bidirectional Ethernet data transceiving function to send read request, write request, read response and write response control information; and
the routing control module has a flow control mechanism, and has functions of sending buffer back pressure and receiving buffer back pressure to control data transmission at a receiving end and a sending end.

In one embodiment, the multiple reconfigurable processing elements on the reconfigurable processor chip are divided into multiple computing areas based on algorithm mapping requirements; and the reconfigurable processor cluster is configured to support flexible division of the computing areas, and support asynchronous parallel computing on the computing areas.

In one embodiment, the reconfigurable processor cluster is configured to support multiple computing modes, a data parallel computing mode, a pipeline parallel computing mode or a model parallel computing mode; and/or
resources of the reconfigurable processor cluster are allocated to multiple tasks for parallel computing.

The above and other objects, advantages and features of the present disclosure will become more apparent to those skilled in the art from the following detailed description of specific embodiments thereof taken in conjunction with the accompanying drawings.

### BRIEF DESCRIPTION OF THE DRAWINGS

Some specific embodiments of the present disclosure will be described in detail hereinafter by way of example and not by way of limitation with reference to the accompanying drawings. The same or similar elements or parts are denoted by the same reference numerals throughout the accompanying drawings. Those skilled in the art will appreciate that the drawings are not necessarily to scale, in which:

FIG. 1 is a schematic diagram illustrating an architecture of a reconfigurable processor chip according to embodiments of the present disclosure;

FIG. 2 is a schematic diagram illustrating a parallel mode of a reconfigurable processor according to embodiments of the present disclosure;

FIG. 3 is a schematic diagram illustrating a parallel reconfigurable processor chip cluster according to embodiments of the present disclosure;

FIG. 4 is a schematic diagram illustrating fault tolerance mechanism of a reconfigurable processing chip according to embodiments of the present disclosure.

### DETAILED DESCRIPTION

It should be noted that embodiments and features of embodiments in the present disclosure may be combined with each other without conflict. The present disclosure will now be described in detail in conjunction with embodiments with reference to the accompanying drawings.

In order to enable those skilled in the art to understand the technical solutions of the present disclosure, the embodiments of the present disclosure will be clearly and completely described in conjunction with accompanying drawings in the embodiments of the present disclosure. Obviously, the embodiments described here are only some of the embodiments of the present disclosure and are not all embodiments of the present disclosure. Based on the embodiments of the present disclosure, other embodiments obtained by those skilled in the art without creative labor are within scope of the present disclosure.

It should be noted that the terms “first”, “second”, and the like in the specification and the claims of the present disclosure, as well as in the accompanying drawings, are used for distinguishing between similar objects, but are not necessarily used for describing a particular sequential or chronological order. It should be understood that the terms thus used are interchangeable under appropriate circumstances such that embodiments of the present disclosure are described herein. Furthermore, the terms “including” and “comprising”, as well as any variations thereof, are intended to cover a non-exclusive inclusion, for example, a process, method, system, product, or apparatus that includes a series of steps or elements is not necessarily limited to those steps or elements expressly listed, but may include other steps or elements not expressly listed or inherent to such a process, method, product, or apparatus.

It should be noted that the terminology used herein is for the purpose of describing particular embodiments only and is not intended to limit the exemplary embodiments according to the present disclosure. As used herein, the terms “a”, “an”, and “the” in singular forms are intended to include the plural forms as well, unless the context clearly indicates otherwise. Moreover, it should be understood that the terms “comprising” and/or “including”, when used in the specification, specify the presence of features, steps, operations, devices, components, and/or combinations thereof.

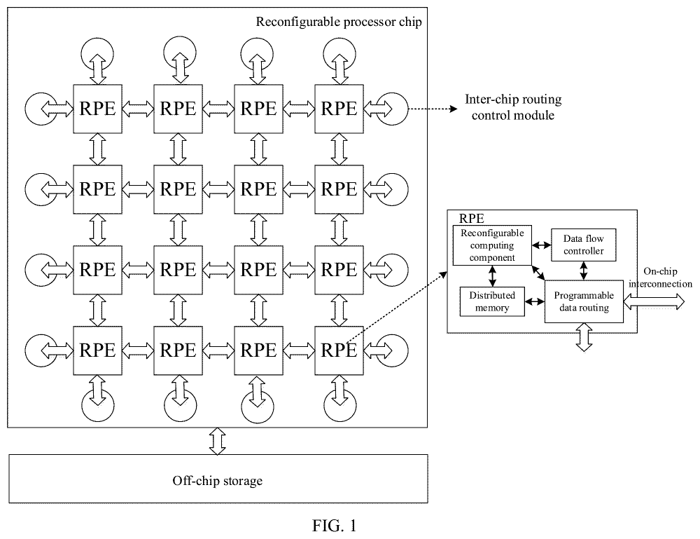

FIG. 1 is a schematic diagram illustrating an architecture of a reconfigurable processor chip according to embodiments of the present disclosure. As shown in FIG. 1, the reconfigurable processor chip includes: multiple reconfigurable processing elements based on distributed storage, components of the reconfigurable processing elements being logically interconnected, where the components include:
a reconfigurable computing component configured to calculate data;
a data flow controller using a data flow driving mode, the data flow driving mode being configured to control start and end of a computing task and a data transmission task based on data flow information about the computing task and message transferring of upstream and downstream reconfigurable processing elements;
a distributed memory configured to implement data storage of a corresponding reconfigurable processing element; and
a programmable data routing element configured to implement communication between the multiple reconfigurable processing elements to control a direction of a data packet, and implement flexible transmission of the data packet.

In one embodiment, the programmable data routing element is configured to change a routing direction and a routing destination of the data packet in real time by software configuration using a software programmable routing policy.

In one embodiment, the reconfigurable processing element is configured to exchange data over a network-on-chip, an inter-chip interface and a network cable within a storage capacity range of a storage space.

In one embodiment, the multiple reconfigurable processing elements are divided into multiple computing areas based on algorithmic mapping requirements, where a communication connection relationship of the programmable data routing element is changed in real time by changing configuration of an execution graph in the reconfigurable processing elements in the data flow driving mode of the data flow controller, and a division of the computing areas is changed based on the communication connection relationship.

In one embodiment, the multiple computing areas perform pipeline computing or perform different assigned computing tasks.

Specifically, a processor of the reconfigurable processor chip is internally composed of the multiple reconfigurable processing elements (RPEs), and unlike a conventional instruction flow driving computing element, the RPE uses the data flow driving mode, and is configured to control the start and end of the computing task based on the data flow information about the computing task and the message transferring of the upstream and downstream RPEs, which belongs to a data flow driving processing element. Moreover, unlike a traditional GPU stream processor, the RPE internally uses a separate storage space, which is not shared with other RPEs. Communication between the RPEs is performed via an autonomously controlled programmable data routing unit (DRU). The DRU is tightly coupled with an on-chip routing control module to control a direction of on-chip interconnection of the data packet via the DRU, and to configure the interconnection in real time to implement transmission of the data packet. The DRU is configured to change the routing direction and the routing destination of the data packet in real time by the software configuration using the software programmable routing policy. Furthermore, in a case where a corrupted processing element may be encountered, a routing path may be modified by the software configuration to bypass the corrupted processing element or chip.

Moreover, in order to support expansion of a large-scale model and requirements of a parallel mode, the reconfigurable processor chip supports that the RPE is divided into the multiple computing areas. The multiple computing areas perform the pipeline computing or perform the different assigned computing tasks. Furthermore, a communication connection relationship of a data routing component is changed in real time by changing the configuration of the execution graph in the PRE in the data flow driving mode, and the division of the computing areas is changed to meet parallel requirements of different task segments.

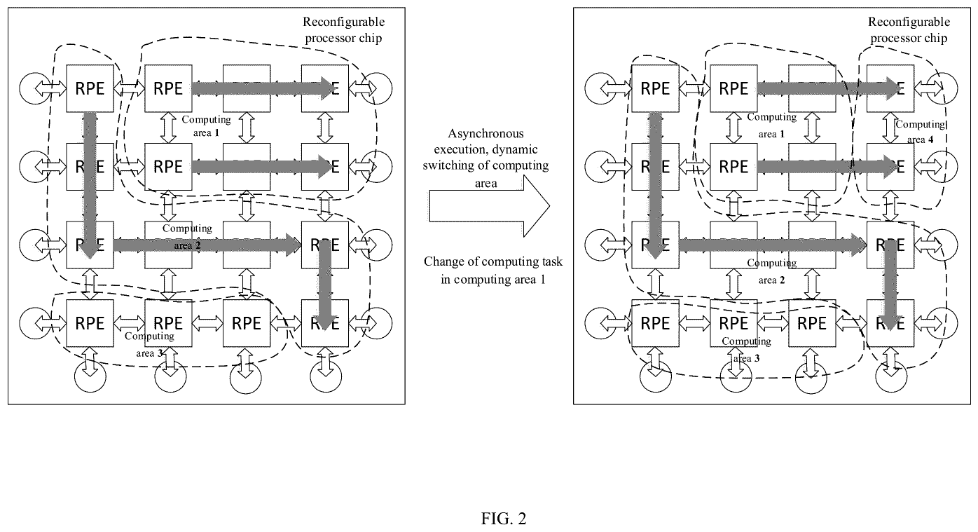

As shown in FIG. 2, the interior of the reconfigurable processor chip is divided into three computing areas, with different computing areas performing three different computing tasks simultaneously and asynchronously. In a computing area 1, communication between the RPEs is performed via the DRU, and an arrow shows a communication relationship between the RPEs.

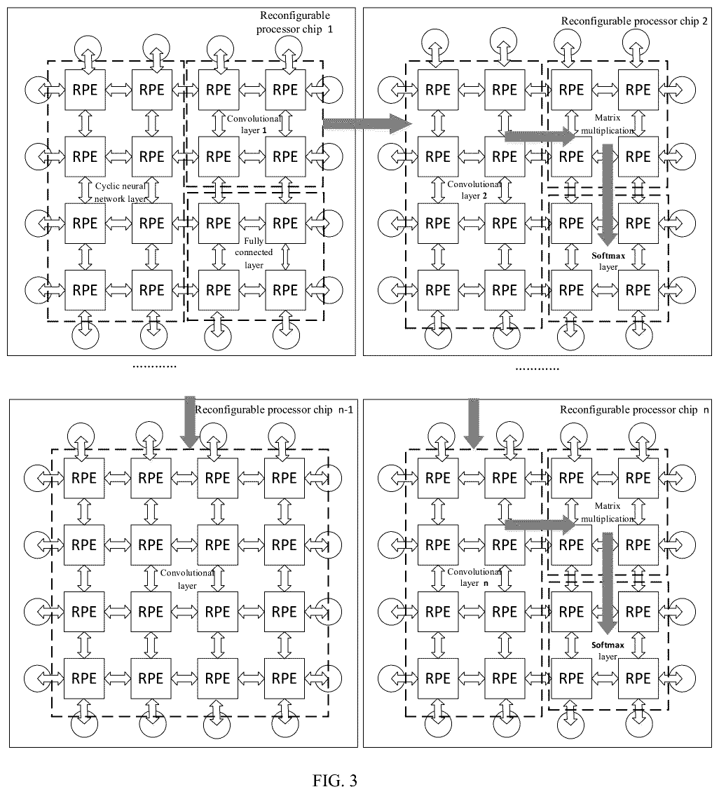

Furthermore, FIG. 3 is a schematic diagram illustrating a reconfigurable processor cluster according to embodiments of the present disclosure. As shown in FIG. 3, the reconfigurable processor cluster includes: multiple reconfigurable processor chips, where the reconfigurable processor chip is composed of the multiple reconfigurable processing elements based on the distributed storage, and the components of the reconfigurable processing elements are logically interconnected and include:
the reconfigurable computing component configured to calculate the data;
the data flow controller using the data flow driving mode, the data flow driving mode being configured to control the start and end of the computing task and the data transmission task based on the data flow information about the computing task and message transferring of the upstream and downstream RPEs;
the distributed memory configured to implement the data storage of the corresponding reconfigurable processing element; and
the programmable data routing element configured to implement the communication between the multiple reconfigurable processing elements to control the direction of the data packet, and implement the flexible transmission of the data packet.

In one embodiment, the reconfigurable processor cluster further includes: a routing control module configured to implement data communication among the multiple reconfigurable processor chips, where
the reconfigurable processing element among the multiple reconfigurable processor chips is configured to perform the data communication via a network by the programmable data routing element and the routing control module, and the programmable data routing element and the routing control module on the reconfigurable processor chip are connected by the network on the reconfigurable processor chip; and
the routing control module is configured to receive or send a network data packet among the reconfigurable processor chips.

In one embodiment, the routing control module has a bidirectional Ethernet data transceiving function to send read request, write request, read response and write response control information; and
the routing control module has a flow control mechanism, and has functions of sending buffer back pressure and receiving buffer back pressure to control data transmission at a receiving end and a sending end.

In one embodiment, the multiple reconfigurable processing elements on the reconfigurable processor chip are divided into the multiple computing areas based on algorithm mapping requirements; and
the reconfigurable processor cluster is configured to support flexible division of the computing areas, and support asynchronous parallel computing on the computing areas.

In one embodiment, the reconfigurable processor cluster is configured to support multiple computing modes, a data parallel computing mode, a pipeline parallel computing mode or a model parallel computing mode; and/or
resources of the reconfigurable processor cluster are allocated to multiple tasks for parallel computing.

Specifically, referring to FIG. 3, the multiple reconfigurable processor chips may be expanded into a large-scale distributed computing chip cluster based on a distributed storage architecture to form a large-scale parallel reconfigurable processing cluster.

Communication between the reconfigurable processor chips may be implemented via an inter-chip routing control module (C2C CTRL), and the chips may be interconnected via a physical interface and a network cable without switching via a switch. The RPEs between the chips may perform data communication via control of the DRU and C2C CTR.

The C2C CTRL may be configured to receive or send the network data packet between the chips, convert the data packet sent out by the RPE in the chips into the network data packet, and perform chip to chip transmission of the chips via a network interface (for example, a 100GE fiber interface, a 10GE fiber interface and the like). Moreover, the network data packet may further be converted into a data packet format used by the RPE inside the chips, and the data packet is sent to an on-chip RPE. The module has the bidirectional Ethernet data transceiving function to send the read request, write request, read response and write response control information. The module has the flow control mechanism, and has the functions of sending the buffer back pressure and receiving the buffer back pressure to control the data transmission at the receiving end and the sending end. Furthermore, a data packet retransmission mechanism is supported to ensure reliability of system transmission.

In a server cluster composed of traditional CPU or GPU processors, data transmission between the processors will first transfer data to an external memory (such as HBM), and then the data is transferred to an external memory in a destination server via the network through multiple memory copies, and then transported via remote direct memory access (RDMA). Typically in a large-scale server scenario, network communication via the switch is further required. However, with the method proposed in the present disclosure, data transmission of a reconfigurable processor across the chip or across the network may be completed only via a C2C CTRL module; and within a capacity range of a RPE memory, data transmission between the RPEs may be performed directly over the network-on-chip, the inter-chip interface and the network cable without external storage and a network switch. This allows for large-scale flexible expansion of multiple chips while reducing cost of cross-chip data communication. Yet another key feature is that the routing direction and the routing destination of the data packet are changed in real time by the software configuration. In the case where the corrupted processing element may be encountered, the routing path may be modified by the software configuration to bypass the corrupted processing element or chip.

Moreover, a multi-chip computing cluster is further configured to support the flexible division of the computing areas, and support the asynchronous parallel computing on the computing areas. A large-scale intelligent computing task may be flexibly mapped onto a chip cluster, and is configured to support the multiple computing modes, the data parallel computing mode, the pipeline parallel computing mode or the model parallel computing mode. As shown in FIG. 3, the multiple reconfigurable processor chips form the large-scale parallel reconfigurable processing cluster. A whole computing task is flexibly mapped on the reconfigurable chip cluster, and performance of a whole intelligent computing task may be optimized by adjusting the parallel computing modes or resource allocation. For example, as shown in FIG. 3, a convolutional layer 1 of the reconfigurable processor chip uses four RPEs for the parallel computing, while a convolutional layer 2 uses eight RPEs for the parallel computing, and following matrix multiplication and softmax also use four RPEs for the parallel computing respectively. Furthermore, a pipeline parallel relationship is formed between the computing areas of the convolutional layer 1 and several computing areas of the convolutional layer 2, matrix multiplication and softmax. Therefore, a deep neural network model is parallelized and expanded on the chip cluster, and a processor resource of the chip may be maximally utilized to fully implement parallelization. In a case where the RPEs in different computing areas of the chip performs communication, the data is forwarded out via the DRU in the RPE, and the DRU in the RPE passing on a communication route may have a data forwarding function, and there is no need to perform communication via a device such as the switch in a case where the data crosses the chip.

Furthermore, a computing resource of the cluster further support simultaneous deployment of the multiple tasks, and a resource of the cluster may be allocated to the multiple tasks for the parallel computing. Simultaneous execution of a cyclic neural network layer, a convolutional layer, or a matrix multiplication task is illustrated in FIG. 3. In a reconfigurable distributed computing architecture, each of the computing areas further uses a full-asynchronous execution mode without global synchronization control, and the RPE in each of the computing areas executes tasks under driving of a data flow according to configuration information therein. Once computing data is received, the RPE in the computing areas may start performing corresponding computing task.

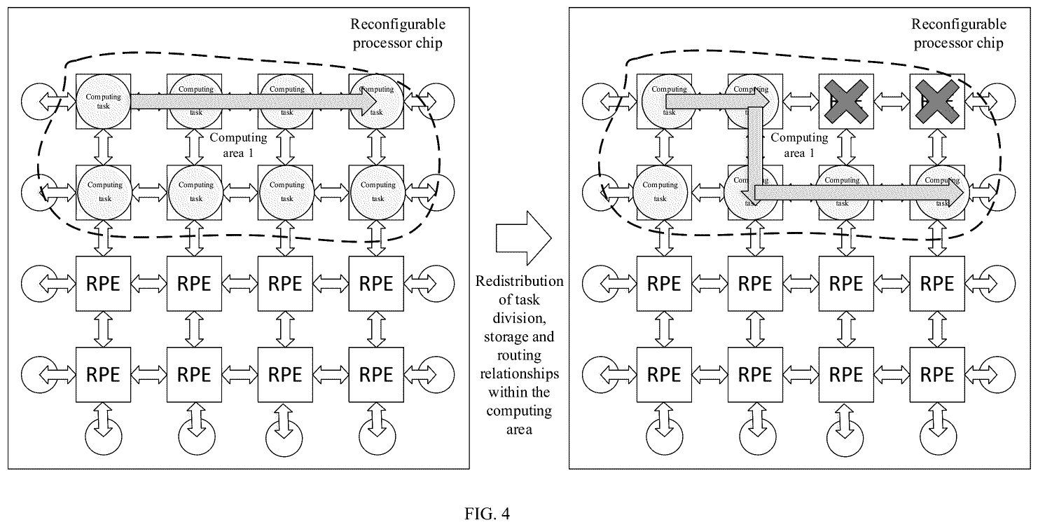

Allocation of the computing resource by the chip takes into account a fault-tolerant mechanism of the chip and the processing element within the chip. In a case where an accident or damage occurs to the chip or the processing element, and the RPE inside the computing area is damaged, the task is reallocated on a normally working RPE by means of reallocating task mapping in the computing area and modifying the mapping mode of the computing area, and data routing information and data flow information about the RPE are modified. As shown in FIG. 4, an original task is allocated in a left graph, and an arrow indicates a routing path of a computing node. In a right graph in FIG. 4, two RPEs in the computing area are damaged, and then the computing task is re-divided according to a number of available computing elements of the computing area, and the configuration information about task allocation and a data routing mode is changed. Problems of reconfiguration of software and hardware, influence on work of the system and the like caused by damage of a chip node or the processing element are avoided.

Therefore, with the present disclosure, the method optimizes a data transmission mechanism between the chips, reduces cost of cross-chip data transmission, and is critical for optimizing performance and cost of a large-scale chip cluster.

The data-flow-driven reconfigurable processor chip and reconfigurable processor cluster provided in the present disclosure have the following technical advantages.
1) The reconfigurable processing element uses the data flow driving computing mode, the data flow driving computing mode is configured to control the start and end of the computing task based on the data flow information about the computing task and message transferring of the upstream and downstream RPEs to implement the asynchronous parallel computing of each computing element.
2) A processor single chip and the chip cluster may be configured to support the data parallel computing mode, the pipeline parallel computing mode and the like of the computing task by using a method for dynamically reconstructing the computing area according to feature of a task data flow, which may flexibly expand distribution of computing power. By optimizing the parallel computing mode, utilization rate of the computing power may be improved and performance of distributed processing of the artificial intelligence algorithm may be optimized under the same computing power.
3) A real-time reconfigurable distributed data exchange mode has no central data exchange node, and problems of congestion and delay of the data communication during large-scale parallelization of the artificial intelligence algorithm are solved. The processing elements of the reconfigurable processor use a distributed storage element, each of the processing elements has an independent data routing module therein, and the processing elements do not need to exchange data via a shared storage element, which avoids a problem of a storage wall caused by large-scale central data transmission and a problem of communication delay caused by large-scale centralized memory access.
4) In a case where the chip is used for a large-scale cluster, and the chip or a processing element in the chip is damaged, the software configuration may be used to avoid the damage. The processing element of the reconfigurable processor is configured to change the routing direction and the routing destination of the data packet in real time by the software configuration using the software programmable routing policy. In the case where the corrupted processing element may be encountered, the routing path may be modified by the software configuration to bypass the corrupted processing element or chip.
5) Reconfigurable chips are flexible and expandable, and data transmission of reconfigurable processor chips across the chip or across the network is accomplished via an inter-chip routing module. Data exchange between the RPEs may be directly carried out over the network-on-chip, the inter-chip interface or the network cable without high-delay external storage, and the switch is not needed for communication, which can effectively reduce cost of cross-chip data communication and alleviate the problem of communication bottleneck caused by parallelization of artificial intelligence tasks on the multiple chips.

Accordingly, the reconfigurable processing element in the reconfigurable processor chip provided by the present disclosure uses a data flow driving computing mode, and the data flow driving computing mode is configured to control the start and end of the computing task based on the data flow information about the computing task and message transferring of upstream and downstream reconfigurable processing elements to implement asynchronous parallel computing of individual computing elements. Processing elements of a reconfigurable processor use the distributed memory, each of the processing elements has an independent data routing module therein, and the processing elements do not need to exchange data via a shared storage element, which avoids a problem of a storage wall caused by large-scale central data transmission and a problem of communication delay caused by large-scale centralized memory access. The processing elements of the reconfigurable processor is configured to change the routing direction and the routing destination of the data packet in real time by the software configuration using the software programmable routing policy. In a case where a corrupted processing element may be encountered, a routing path may be modified by the software configuration to bypass the corrupted processing element or chip. Furthermore, a mapping mode of the computing area is modified, the task is reallocated on the RPE which normally works, and data routing information and data flow information about the RPE are modified.

The relative arrangement of components and steps, numerical expressions and numerical values described in these embodiments are not intended to limit the scope of the present disclosure unless otherwise specified. Moreover, it should be understood that the dimensions of the various components illustrated in the drawings are not drawn to scale for ease of description. Techniques, methods, and devices known to those skilled in the relevant art may not be discussed in detail, but should be considered as part of the authorization specification where appropriate. In all embodiments shown and discussed herein, any particular value should be interpreted as illustrative only and not as a limitation. Therefore, other examples of exemplary embodiments may have different values. It should be noted that: like numbers and letters refer to like items in the following drawings, and thus, once an item is defined in one figure, further discussion thereof is not required in subsequent drawings.

For ease of description, spatial relative terms, such as “on”, “above”, “on an upper surface of”, “on top of” and the like, may be used herein to describe a spatial positional relationship between a first device or feature and a second device or feature as shown in the drawings. It is to be understood that the spatial relative terms are intended to include different orientations in use or operation in addition to the orientation described in the drawings. For example, in a case where the device in the drawings is inverted, the device described as “above” or “on top of” other devices or structures would then be positioned “below” or “beneath” other devices or structures. Therefore, the exemplary term “above” may include both “above” and “below” orientations. The device may further be positioned in various other ways (rotated 90 degrees or at other orientations), and the spatial relative description used here should be explained accordingly.

In the description of the present disclosure, it is to be understood that the directional terms such as “front, rear, up, down, left, right”, “transverse, vertical, perpendicular, horizontal”, “top, bottom”, and the like indicate directional or positional relationships that are generally based on the directional or positional relationships shown in the drawings merely for convenience in describing the present disclosure and simplifying the description, and do not indicate or imply that the device or element referred to must have a particular orientation or be constructed and operated in a particular orientation without departing from the scope of the present disclosure, and thus cannot be construed to limit the scope of the present disclosure. The directional terms “inner” and “outer” refer to inner and outer relative to the contour of each component itself.

The above embodiments are only the preferred embodiments of the present disclosure, but the scope of the present disclosure is not limited thereto. It would be appreciated by those skilled in the art that, without departing from principles of the present disclosure, changes and alternatives may be easily made, which are covered by the protection scope of the present disclosure. Therefore, the protection scope of the present disclosure is defined according to the appended claims.

What is claimed is:

1. A reconfigurable processor chip, comprising: a plurality of reconfigurable processing elements based on distributed storage, components of the reconfigurable processing elements being logically interconnected, wherein the components comprise:
a reconfigurable computing component configured to calculate data;
a data flow controller using a data flow driving mode, the data flow driving mode is configured to control start and end of a computing task and a data transmission task based on data flow information about the computing task and message transferring of upstream and downstream reconfigurable processing elements;
a distributed memory configured to implement data storage of a corresponding reconfigurable processing element; and
a programmable data routing element configured to implement communication between the plurality of reconfigurable processing elements to control a direction of a data packet, and implement flexible transmission of the data packet.

2. The reconfigurable processor chip of claim 1, wherein the programmable data routing element is configured to change a routing direction and a routing destination of the data packet in real time by software configuration using a software programmable routing policy.

3. The reconfigurable processor chip of claim 1, wherein the reconfigurable processing element is configured to exchange data over a network-on-chip, an inter-chip interface and a network cable within a storage capacity range of a storage space.

4. The reconfigurable processor chip of claim 1, wherein the plurality of reconfigurable processing elements are divided into a plurality of computing areas based on algorithmic mapping requirements, wherein
a communication connection relationship of the programmable data routing element is changed in real time by changing configuration of an execution graph in the reconfigurable processing elements in the data flow driving mode of the data flow controller, and a division of the computing areas is changed based on the communication connection relationship.

5. The reconfigurable processor chip of claim 4, wherein the plurality of computing areas perform pipeline computing or perform different assigned computing tasks.

6. A reconfigurable processor cluster, comprising: a plurality of reconfigurable processor chips, wherein the reconfigurable processor chip is composed of a plurality of reconfigurable processing elements based on distributed storage, and components of the reconfigurable processing elements are logically interconnected and comprise:
a reconfigurable computing component configured to calculate data;
a data flow controller using a data flow driving mode, the data flow driving mode is configured to control start and end of a computing task and a data transmission task based on data flow information about the computing task and message transferring of upstream and downstream reconfigurable processing elements;
a distributed memory configured to implement data storage of a corresponding reconfigurable processing element; and
a programmable data routing element configured to implement communication between the plurality of reconfigurable processing elements to control a direction of a data packet, and implement flexible transmission of the data packet.

7. The reconfigurable processor cluster of claim 6, further comprising: a routing control module is configured to implement data communication among the plurality of reconfigurable processor chips, wherein
the reconfigurable processing element among the plurality of reconfigurable processor chips is configured to perform the data communication via a network by the programmable data routing element and the routing control module, and the programmable data routing element and the routing control module on the reconfigurable processor chip are connected by the network on the reconfigurable processor chip; and
the routing control module is configured to receive or send a network data packet among the reconfigurable processor chips.

8. The reconfigurable processor cluster of claim 7, wherein the routing control module has a bidirectional Ethernet data transceiving function to send read request, write request, read response and write response control information; and
the routing control module has a flow control mechanism, and has functions of sending buffer back pressure and receiving buffer back pressure to control data transmission at a receiving end and a sending end.

9. The reconfigurable processor cluster of claim 6, wherein the plurality of reconfigurable processing elements on the reconfigurable processor chip are divided into a plurality of computing areas based on algorithm mapping requirements; and
the reconfigurable processor cluster is configured to support flexible division of the computing areas, and support asynchronous parallel computing on the computing areas.

10. The reconfigurable processor cluster of claim 6, wherein the reconfigurable processor cluster is configured to support a plurality of computing modes, a data parallel computing mode, a pipeline parallel computing mode or a model parallel computing mode.

11. The reconfigurable processor cluster of claim 6, wherein resources of the reconfigurable processor cluster are allocated to a plurality of tasks for parallel computing.

12. The reconfigurable processor cluster of claim 6, wherein the programmable data routing element is configured to change a routing direction and a routing destination of the data packet in real time by software configuration using a software programmable routing policy.

13. The reconfigurable processor cluster of claim 6, wherein the reconfigurable processing element is configured to exchange data over a network-on-chip, an inter-chip interface and a network cable within a storage capacity range of a storage space.

14. The reconfigurable processor cluster of claim 6, wherein the plurality of reconfigurable processing elements are divided into a plurality of computing areas based on algorithmic mapping requirements, wherein
a communication connection relationship of the programmable data routing element is changed in real time by changing configuration of an execution graph in the reconfigurable processing elements in the data flow driving mode of the data flow controller, and a division of the computing areas is changed based on the communication connection relationship.

15. The reconfigurable processor cluster of claim 14, wherein the plurality of computing areas perform pipeline computing or perform different assigned computing tasks.
